(19) United States
(12) Patent Application Publication
(10) Pub. No.: US 2024/0075434 A1
(43) Pub. Date: Mar. 7, 2024

(54) WATER TREATMENT SYSTEM WITH RETRIEVABLE MOUNTING FRAME ASSEMBLY FOR DIFFUSORS

(71) Applicant: Claudius Jaeger, Boulder, CO (US)

(72) Inventor: Claudius Jaeger, Boulder, CO (US)

(21) Appl. No.: 18/387,415

(22) Filed: Nov. 6, 2023

Related U.S. Application Data
(63) Continuation-in-part of application No. 17/733,248, filed on Apr. 29, 2022, now Pat. No. 11,806,680.
Application No. 17/733,248 is a division of application No. 16/593,870, filed on Oct. 4, 2019, now Pat. No. 11,433,361.

(51) Int. Cl. B01F 23/231; C02F 3/20

(52) U.S. Cl. CPC B01F 23/2311; C02F 3/20; B01F 23/231142; B01F 23/231143; B01F 2101/305

(57) ABSTRACT

A wall-mounted, retrievable diffusor system for aerating water in a tank includes a guide rail assembly mounted to a tank wall and extending from the tank floor to an upper edge of the wall; a retrievable mounting frame assembly releasably mounted on the guide rail assembly; and a plurality of aeration elements secured to the retrievable mounting frame assembly. The retrievable diffusor system is configured to be raised or lowered into or out of the tank either manually or via a motorized winch. In one aspect, the diffusor system includes guide rollers for guiding the mounting frame along a central guide rail. Swivel rollers engage the central guide rail and enable the mounting frame to be pivoted out of a position perpendicular to the tank wall and into a position over a platform of the tank for maintenance or replacement of the aeration elements when the frame is pulled from the tank.

### PRIORITY APPLICATION

This application claims the benefit of priority to and is a continuation-in-part application of U.S. application Ser. No. 17/733,248 filed Apr. 29, 2022 which is a divisional application of U.S. application Ser. No. 16/593,870, filed Oct. 4, 2019 (now U.S. patent Ser. No. 11/433,361), entitled “Water Treatment System With Retrievable Mounting Frame Assembly For Diffusors,” the entire contents of which are hereby expressly incorporated herein by this reference including, without limitation, the specification, claims, and abstract, as well as any figures, tables or drawings thereof.

### FIELD OF THE INVENTION

The present invention relates generally to wastewater treatment, and more particularly, to retrievable aeration systems utilized in the gasification of liquids of water in wastewater treatment basins.

### BACKGROUND OF THE INVENTION

Activated sludge systems are used to break down organic solids in wastewater by aerobic digestion from microorganisms (biomass). The organisms are then recycled and the remaining products are treated water and waste solids. Carbonaceous Biochemical Oxygen Demand (CBOD) is the amount of carbon-based organic matter in the water that is biodegradable. It is measured as Biochemical Oxygen Demand (BOD). Since this organic matter or nutrients deplete oxygen in the water by digestion of aerobic nutrients by microbes, the goal is to remove the organic solids in the water and lower the BOD level. This is also known as BOD removal. The level of BOD is controlled so that the final decanted water can be released into streams or rivers.

The basic equation for treating BOD with the activated sludge process is BOD+O₂+Bacteria →CO₂+H₂O (BOD+Oxygen →Carbon Dioxide+Water).

Since the microorganisms use oxygen to break down the suspended solids (SS), oxygen must be introduced into the mixture of water and solids. This mixture is called Mixed Liquor Suspended Solids (MLSS). The amount of oxygen must be great enough for the biomass to break down the solids in the resident time in the waste tank. In order to maximize the amount of oxygen that is dissolved in the water (DO), the oxygen transfer efficiency (OTE) is examined. The more oxygen, the better the biomass can feed and maintain the proper biomass to solids ratio (F:M). The organisms and solids form into an aggregate called floc.

Biological nutrient removal is also a part of the activated sludge process, since nitrogen and phosphorus are elements which can promote the growth of noxious algae in surface waters that received treated waste water. Another demand of oxygen in an activated sludge process is created by oxidizing ammonia to nitrates (nitrification).

A general formula is:

NO³−→NO²−→NO→N²O→N² gas

Various types of water-treatment apparatus have been developed and are used, for example, in clarification plants/waste water-processing aerobic digestion tanks. In a typical system, a plurality of aeration elements is disposed on a distribution conduit, whereby the distribution conduit on the one hand serves for the supply of air or gas to the aeration elements, and on the other hand also serves for the securement of the aeration elements. A plurality of distribution conduits can in turn be combined to form a system.

In known systems, tube-, disc-, and/or strip-type diffusor elements are generally fixed to the bottom of a water treatment tank or to the bottom surface of a treatment pond via specialized brackets or are self-weighted so that the aeration elements remain at the bottom of the treatment tank or pond to be treated. Aeration elements are typically arranged in various types of grid configurations or in zones on the bottom of the water tank or pond to be treated. Aeration elements in the form of diffusors strips, tubes, or discs, as are commonly used, are consumable in the activated sludge process, and therefore are subject to a great deal of wear and tear, in that the membrane or other material that surrounds the frame or body of the diffusor element can be damaged by movement of the water around the elements. Such aeration elements, therefore, are routinely replaced every 6 to 10 years. The diffusor element frame/body itself can become clogged with debris or even warped over time, or the clamp, bracket, or other element that secures the aeration element to the tank floor can become worn or damaged and require replacement or repair. Maintenance of the diffusor elements, therefore, can be difficult, expensive, and time-consuming, since any damaged components must be accessed and replaced within the water tank or pond, as the diffusor elements are secured to the bottom of the tank via clamps, brackets, or other securement means, as noted above.

As noted above, typically strip-like or tube-like aeration elements also are secured in place to the floor or bottom of a tank or water to be treated, for example, by means of an assembly bracket or other attachment means. These types of arrangements are known as fixed grid diffusor systems. By way of illustration, with one type of assembly bracket, cooperating upper and lower profiled portions are secured around the aeration element at opposite ends of each element. The assembly bracket is in turn secured to the floor by either an anchor bolt in the center bottom hole directly into the tank floor or by two height-adjustable anchors through the two outer holes to enable leveling of the diffusor to bottom of the tank for maintaining the position of an aeration element. It is contemplated that a plurality of brackets can be utilized along the length of the aeration element, rather than only on its ends.

A disadvantage associated with these types of fixed grid systems in wastewater treatment system operations, however, relates to maintenance of the aeration elements once in place and operating in the water basin. To install, repair, replace, or otherwise access the fixed grid-type diffusor system, the water basin must be drained. Thus, in a wastewater treatment plant, the aeration basin must be shut down completely at this point, interrupting processing, unless the system includes a second tank or basin that can still be operated while the first tank is not in use.

A retrievable and modular system, therefore, offers built-in redundancy, that is, 100% uptime, as the basin and the entire aeration system must not be taken out of service during repair and maintenance operations, thus offering much lower costs with regard to operation and maintenance.

The retrievable diffusor frame based on a bridge-mounted system according to the present application therefore overcomes the limitations of a wall-mounted system by spanning across the tank, in the event the geometry of the tank does not provide for a sufficient number of diffusor frames or diffusor coverage on the bottom of the tank or for air distribution in the center of the tank. The system further eliminates the need for parallel or redundant tank systems.

The system of the present application further facilitates replacement and maintenance operations for the diffusors and frames by providing a transfer system including transport device for the diffusor frames or racks and transferrable crane that enables the frames and diffusors to be moved along the bridge into position for deployment or removal at selected positions along the length of the bridge.

Thus, according one embodiment, rather than securing the aeration elements to the tank or pond floor via clamping bracket or other means in a fixed-grid type of system, the aeration elements are secured onto a retrievable mounting frame or rack that can be lowered into or raised out of the tank via a guide rail system that is secured to a bridge spanning the tank. Further, unlike known retrievable diffusors used in water treatment which are commonly mounted to the wall of the tank or basin, the system assembly according to the present application instead allows access to the entire contents of the tank or basis by providing a bridge-mounted system that can be configured depending on the geometry and dimensions of the tank or basin. The system increases operating efficiency by eliminating downtime involved with draining the tank when repair or maintenance to the system is required.

According to a further aspect of the invention, when the tank size and configuration does not permit the use of a bridge or walkway system, a wall-mounted system is provided, in which the guide rail system may be secured to the wall of a tank and the bridge and walkway system are eliminated. Unlike known wall-mounted systems, however, the wall-mounted guide rail and aeration rack design described herein allows for easier maintenance by providing both a lift-out and a swivel design for removing and/or replacing the aeration elements.

As noted above, the system according to the present invention allows deployment of more retrievable aeration elements per tank, compared to solely wall mounted systems, thereby overcoming tank width and/or diameter limitation of rectangular or round tanks. The system therefore provides for a greater aeration capacity using retrievable diffusors compared to round tanks. The width/diameter limitation of solely wall mounted retrievable system is approximately 60 ft (18.25 m).

### SUMMARY OF THE INVENTION

Embodiments of the present invention address the above-noted disadvantages by providing a novel wastewater treatment system with a bridge-mounted, retrievable aeration system.

Aspects of the invention are directed to a water treatment system for use in a water treatment basin with a bridge assembly extending between walls of the tank and a retrievable aeration assembly with a guide rail system fixed to the bridge for deploying and retrieving the diffusor frame assembly. The system further includes a transport system for moving and deploying the diffusor assemblies that includes a transport device for moving the frame assemblies along the length of the bridge and a transferrable crane moveable between lifting positions along the bridge for moving the frame assemblies between the guide rail system and the transfer device. By providing a bridge system that spans the tank and is situated above the surface of the water and a retrievable aeration element frame assembly that can be deployed from selected positions on the bridge system, the aeration elements and frames can be replaced or maintained when necessary, without draining the water from the tank and without requiring a second tank for redundancy.

Aspects of the present invention is a water treatment system that includes at least one bridge assembly that spans a water treatment tank; at least one retrievable diffusor frame assembly for diffusor elements that is moveable between a raised and lowered position into and out of the water tank; at least one guide rail system fixed to the bridge assembly for moving the frame assembly between a first position above the surface of the water to a second position on a bottom surface of the tank; a transfer device for moving the frame assemblies along the length of the bridge; and a transferable crane moveable between lifting positions along the bridge. The bridge walkway can include integrated guide tracks for accommodating wheels or castors of both the transfer device and transferrable crane. In this connection, the crane can include a base that can be fixed to the bridge or walkway when the crane is in use to move the rack assemblies. Further, to facilitate movement of the crane along the bridge, the crane base can be provided with wheels and/or castors that cooperate with the tracks on the bridge that are also used by the wheels or castors of the transport device, so that the crane assembly can be moved along the bridge or walkway, and then fixed into lifting position for moving the frame assemblies.

Additional aspects of the invention are directed to a method for treating wastewater in a treatment basin or tank. At least one bridge is installed that spans the basin and a plurality of retrievable aeration systems, or guide rail system, are installed at selected positions along the length of the bridge. A transport system is provided that includes a transport device or cart for moving the diffusor frames along the bridge walkway in guide tracks provided in the walkway to the guide rail system and a transferrable crane for moving the diffusor frames between the transport cart and the guide rail system.

Further specific features of the invention will be described in detail subsequently.

### BRIEF DESCRIPTION OF THE DRAWINGS

This object, and other objects and advantages of the present invention, will appear more clearly from the following specification in conjunction with the accompanying schematic drawings, in which:

FIG. 1A shows an isometric view of the water treatment system according to the present invention;

FIG. 1B shows an isometric view of the water treatment system with a rectangular tank configuration with at least two bridge assemblies;

FIG. 1C shows a further isometric view of the system of FIG. 1;

FIG. 2A shows a view of the retrievable aeration system with vertical rail guides and frame assembly of FIG. 1C;

FIG. 2B shows an end elevation view of the bridge with vertical rail guides, frame assembly, and cart of FIG. 2A;

FIG. 3A shows an end elevation view of the bridge assembly, transport cart, retrievable mounting frame assemblies, and a lifting and transfer crane fixed to the bridge assembly for moving and positioning the retrievable mounting frame assemblies;

FIG. 3B shows a perspective view of the lifting and transfer crane with a retrievable mounting frame assembly;

FIGS. 4A and 4B show detail views of the vertical guide rails and guide rails with mounting frame assembly, respectively;

FIGS. 5A-5D show detail views of the retrievable mounting frame assembly with mounting brackets and aeration elements;

FIGS. 5E and 5D illustrate tube and disc diffusors secured to the diffusor frame;

FIG. 6A shows a front view of a portion of the bridge with the portable cart and crane assembly positioned thereon;

FIG. 6B shows a top view of the bridge assembly, a transfer cart with mounting frame assembly on the bridge, and a mounting frame assembly in a lowered position;

FIG. 7 shows a further view of the bridge assembly with a diffusor rack transfer cart supporting a mounting frame assembly;

FIGS. 8A-9B show perspective views of the transferrable crane on the bridge walkway;

FIGS. 10A-10B show perspective views of the transfer crane of FIGS. 9A-10B lifting a mounting frame assembly;

FIGS. 11A-11B show the mounting frame assembly in position on the transfer cart after placement on the cart by the crane;

FIGS. 12A-12E show views of the transferrable crane, transfer trolley, and crane mounting base;

FIG. 13 shows a view of the mounting frame assembly in place on the transfer cart;

FIG. 14 shows the transfer station at an end of the bridge assembly for lifting and transferring the diffusor frame assemblies from or onto the bridge;

FIG. 15 shows a further aspect of the retrievable mounting frame assembly for mounting to a wall of a water treatment tank, with the mounting frame and diffusors secured thereto positioned on the floor of the tank;

FIG. 16 shows the retrievable mounting frame assembly of FIG. 15 in a raised position adjacent the top of the tank wall, where the diffusor rack can be lifted out of the assembly for replacement or maintenance;

FIG. 17 shows a further aspect of a wall-mounted retrievable guide rail assembly with a swivel mount for the diffusor rack/mounting frame;

FIG. 18A is a side view of the wall-mounted guide rail assembly of FIG. 17 including the diffusor mounting frame/rack in a position raised position;

FIG. 18B is a perspective view of the wall-mounted guide rail assembly of FIG. 18A with the diffusor mounting frame/rack in a submerged position on the floor of the tank;

FIG. 18C is a side view of the wall-mounted guide rail assembly of FIG. 18B;

FIG. 19 is a further perspective view of the wall-mounted guide rail assembly of FIGS. 17-18C;

FIG. 20 is a further perspective view of the wall-mounted guide rail assembly of FIGS. 17-18C;

FIG. 21 is a perspective view of the wall-mounted assembly of FIGS. 17-20, showing the diffusor mounting frame/rack in a position swiveled or pivoted around the guide rail and over the tank railing;

FIG. 22 is a detail view of the upper and lower guide rollers;

FIG. 23 is a detail view of the upper and lower guider roller, as well as the swivel plate, yoke, and locking pin; and

FIG. 24 is a bottom sectional, detail view of the lower guide and swivel rollers.

### DETAILED DESCRIPTION OF THE EMBODIMENTS

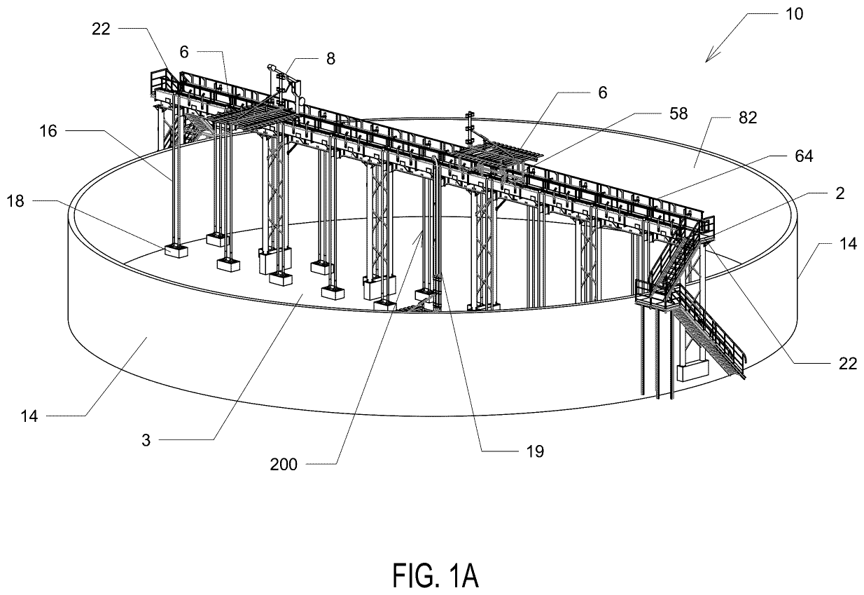

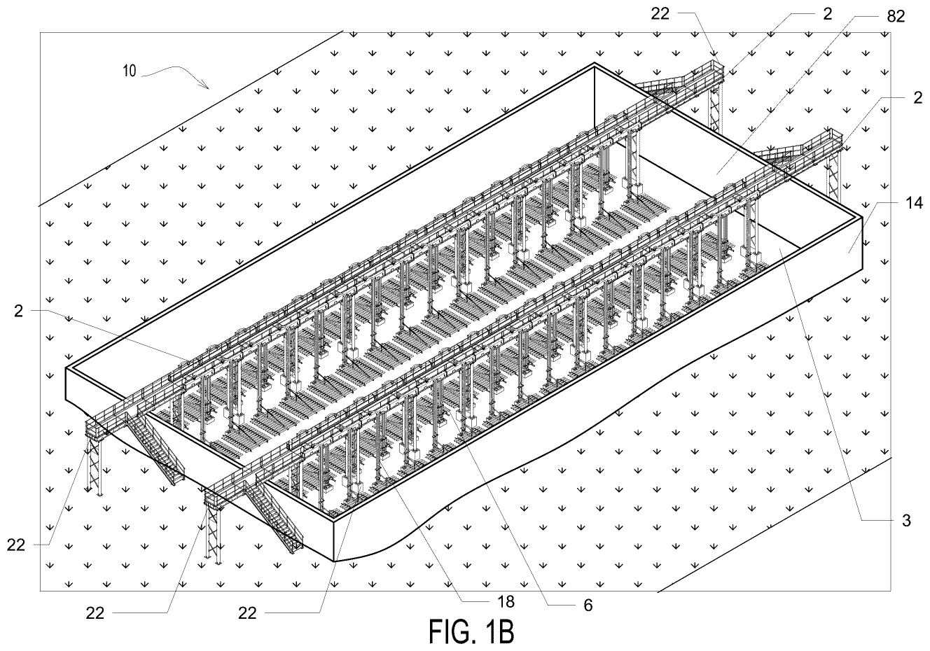

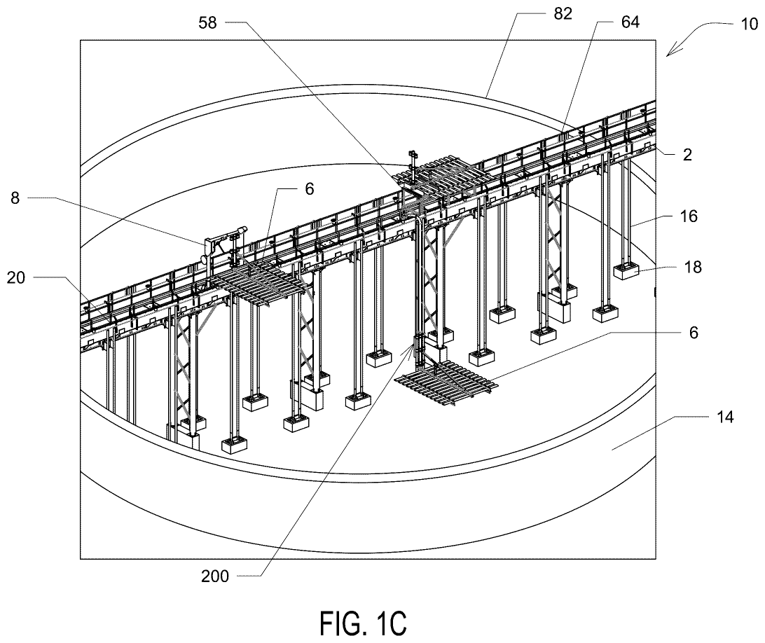

Referring now to the drawings in detail, as shown in FIGS. 1A and 1C, the water treatment system 10 includes at least one bridge 2, a retrievable aeration system 200 including at least one retrievable mounting frame assembly 6 and a vertical guide rail system 19, a transferrable crane or lifting device 8, and a moveable transfer device, or cart 58 for moving the frame assembly along the bridge 2 into position for deployment of the frame assembly and aeration elements into a water treatment tank 14. The water treatment system 10 is shown in FIG. 1A is contemplated for use in a water treatment tank 14, so that the bridge 2 extends across the water treatment tank 14, allowing workers access to the mounting frame assemblies and crane or lifting device 8 through transfers stations 22 on at least one end of the bridge assembly 2, as will be described below. The water treatment system therefore eliminates the need for the retrievable aeration system to be mounted only to the walls of the tank, but instead allows the mounting frame with aeration elements mounted thereon to be placed in a variety of configurations in the water tank, thereby providing more efficient aeration and treatment of the water throughout the entire tank and avoiding draining of the tank for maintenance or repairs.

As noted above, the system according to the present invention allows deployment of more retrievable aeration elements per tank, compared to solely wall mounted systems, thereby overcoming tank width and/or diameter limitation of rectangular or round tanks. The system therefore provides for a greater aeration capacity using retrievable diffusors compared to round tanks. The width/diameter limitation of solely wall mounted retrievable system is approximately 60 ft (18.25 m).

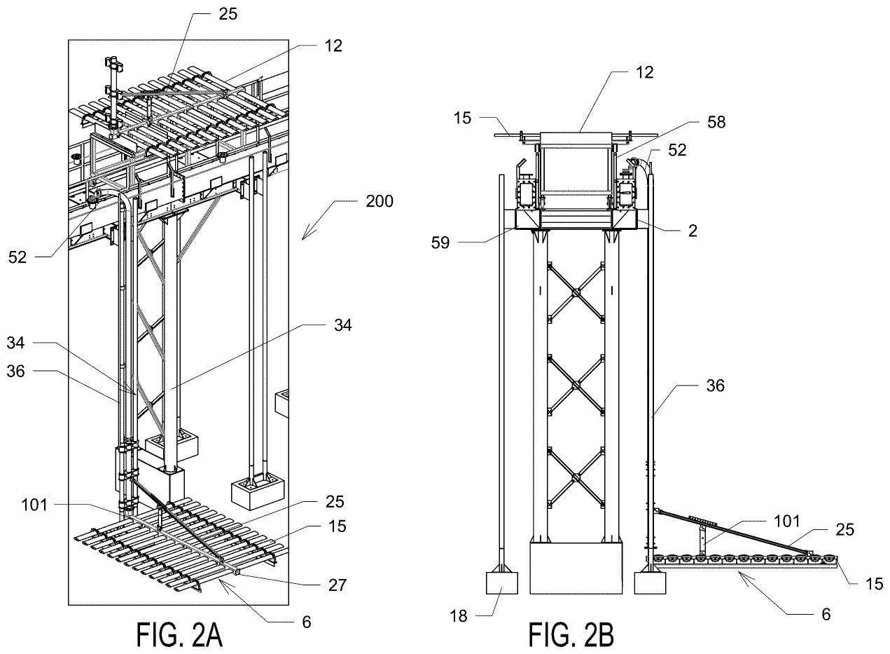

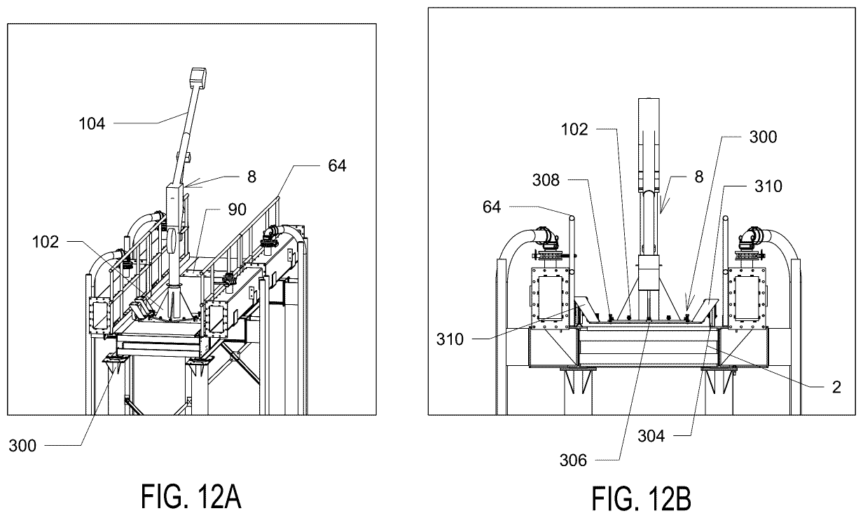

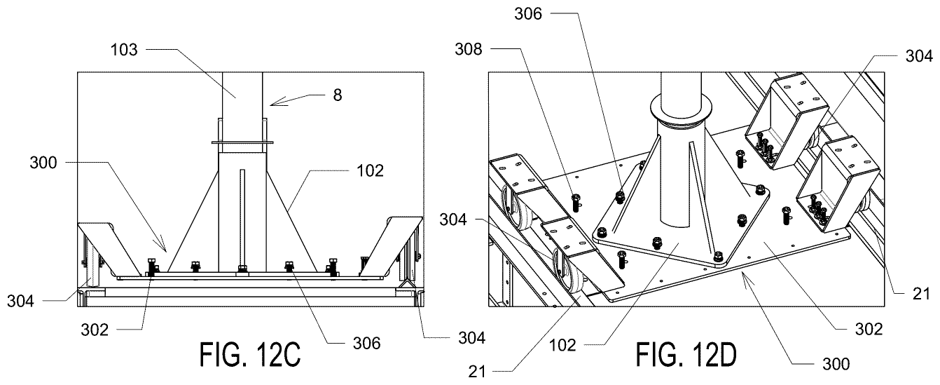

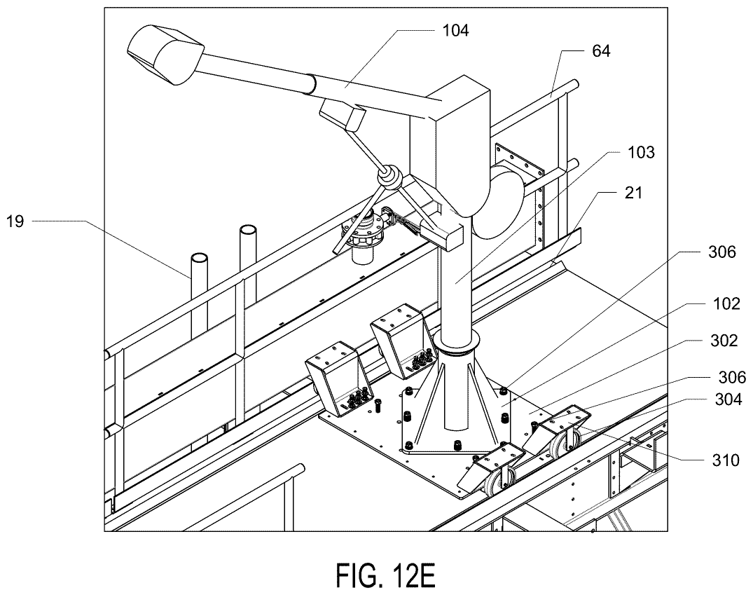

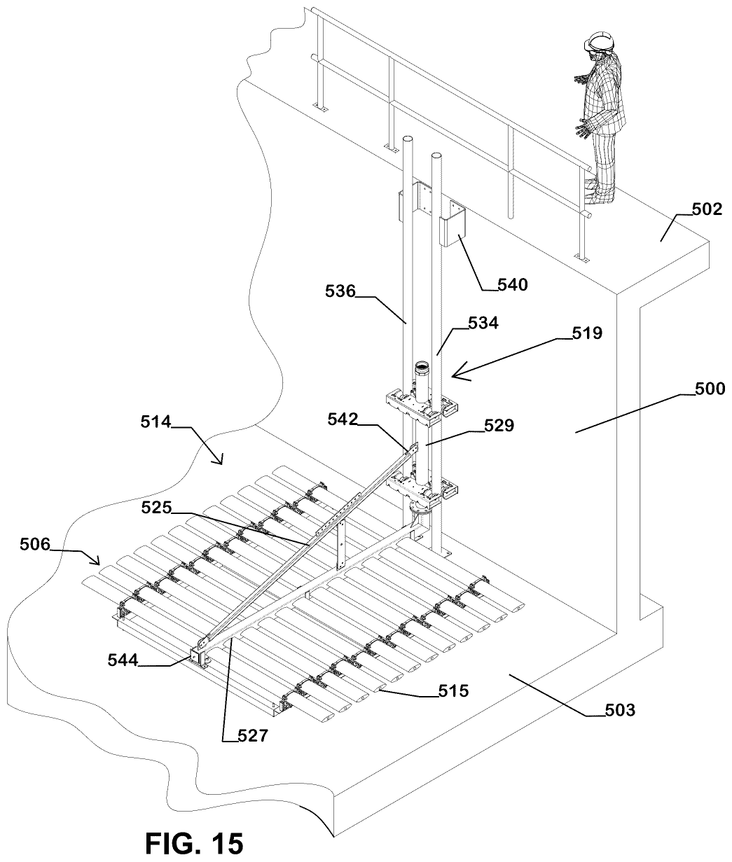

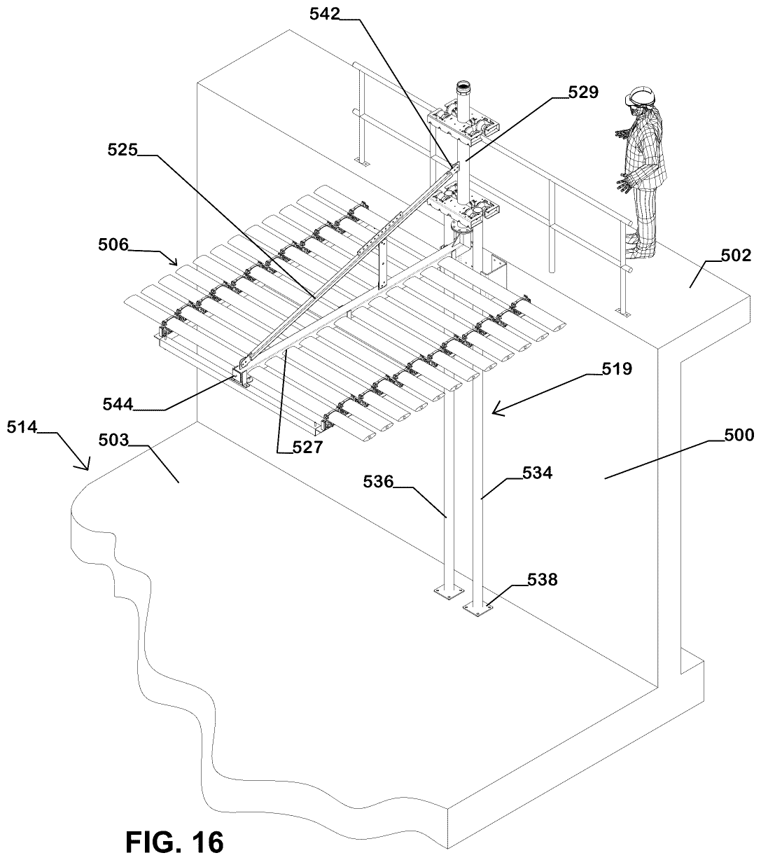

The bridge 2 preferably is constructed of steel and includes a plurality of supports 16, each with a stabilizing base 18 secured to the typically concrete floor 3 of the tank 14. The bridge 2 further includes a walkway, or catwalk, 20 extending across the length of the bridge 2. At least one guide track, preferably two guide tracks 21 positioned parallel to one another, are provided that run the length of the walkway 20 for facilitating movement of the cart 58 and crane 8 along the walkway 20 using wheels or castors on the cart 58 and crane 8, respectively, as will be described below with reference to FIGS. 2a and 12a, for example. That is, the crane 8 and transfer cart 58 preferably can run on the same track system. The bridge assembly further includes transfer stations 22, which are positioned at opposites ends of the walkway and externally to the walls of the tank 14, so that system operators may access the bridge assembly 2 via the transfer stations 22 and load and unload the components of the mounting frame assembly 6, cart 58, and crane 8 for use on the walkway 20. (See also FIG. 15, described below).

As shown in FIG. 1B, one or more bridges 2 may be used, depending on the size and geometry of the water basin. For example, as shown in FIG. 1B, the system allows the use of more than one bridge 2 that span the entire tank 14 and to accommodate a variety of basin configurations, such as the rectangular tank 14 shown in FIG. 1B. While FIG. 1B shows the use of two bridges 2 in a rectangular tank 14, it can be appreciated that the system of the present invention can be utilized in any tank configuration with any number of bridges in any contemplated configuration, depending on the tank geometry.

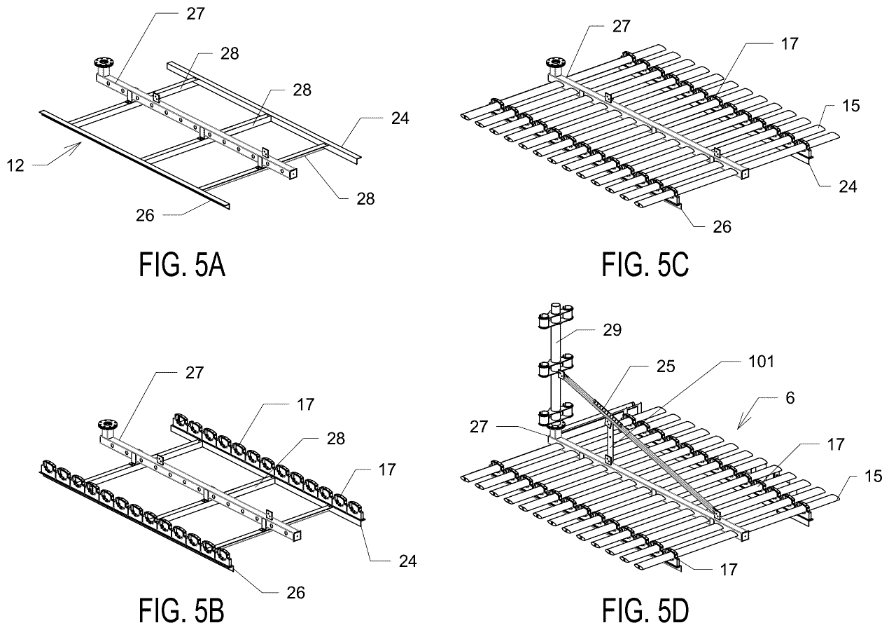

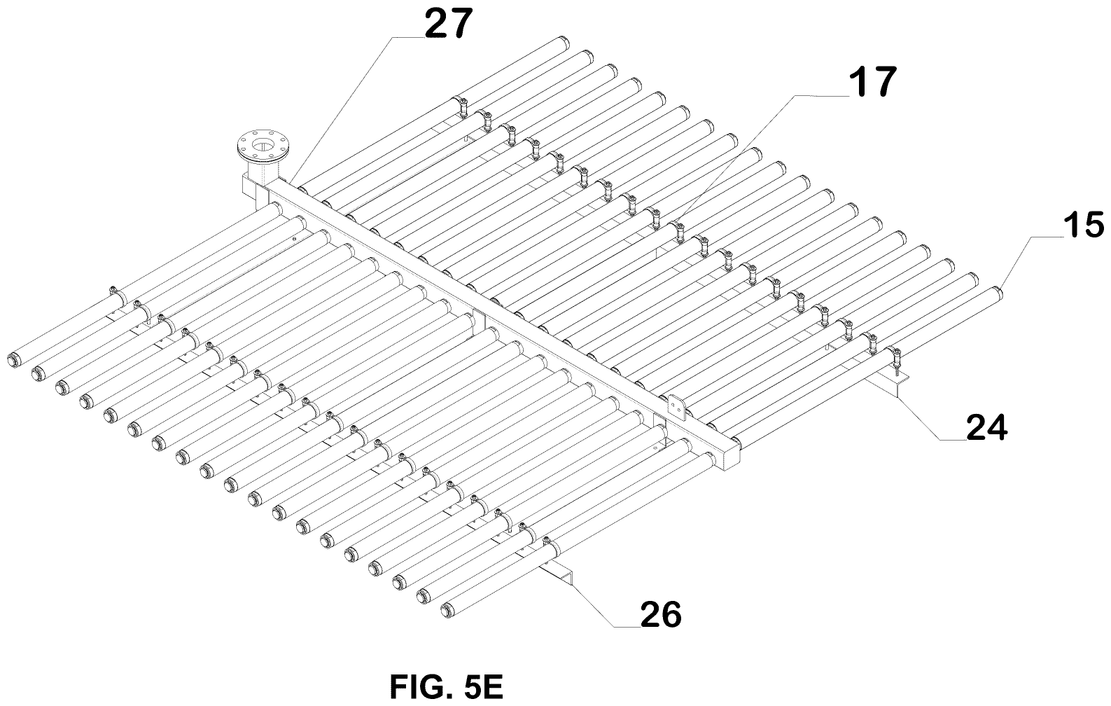

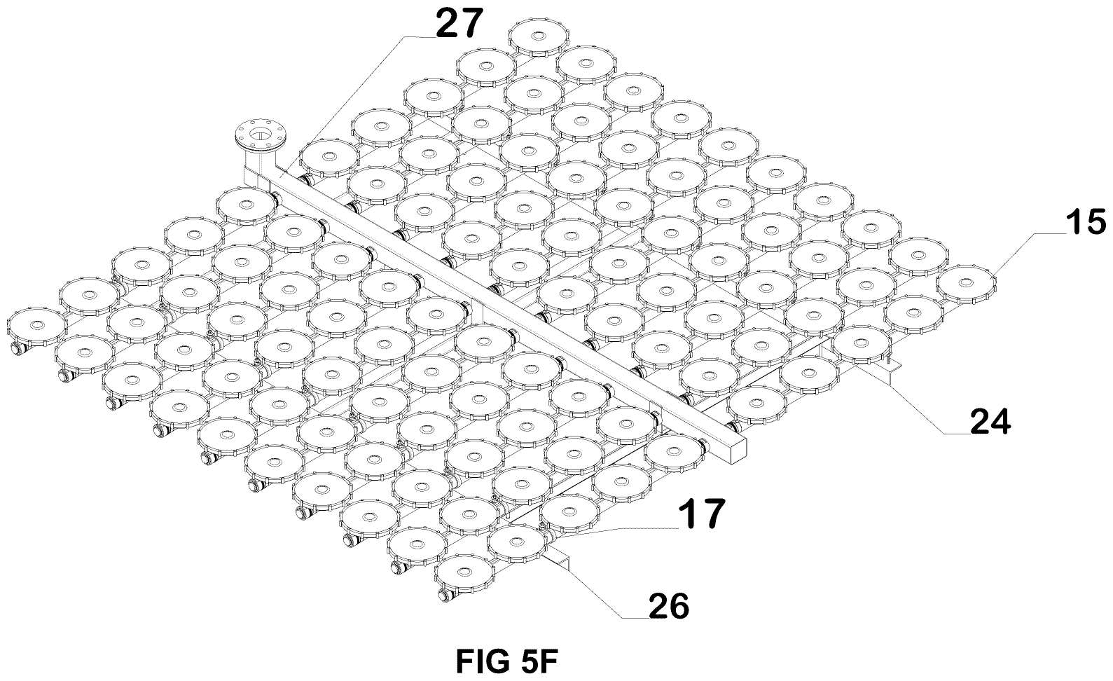

As shown in FIGS. 1C, 2A-2B, and 4A-4B, the retrievable aeration system 200 includes a vertical guide rail assembly 19, mounting frame assembly 6 with a mounting frame 12, and a plurality of aeration elements 15 mounted to the frame 12 via brackets 17 (see also FIGS. 5A-5F, described below). The vertical guide rail assembly 19 serves for transferring the frame assembly 6 between a position above the water's surface and to a position on the floor 3 of the tank 14. The vertical guide rail assembly 19 includes preferably two vertical guide rails 34, 36 positioned parallel to one another and extending from the bridge 2 to the floor 3 of the tank 14, a lower fixing bracket 38 for securing the vertical guide rail assembly 19 to the floor 3 of the tank 14, and an upper fixing bracket 40 for securing the vertical guide rail assembly 19 to a railing or other component of the bridge system 2. A flexible hose 52 provides a supply of air to an air distribution conduit 29 and is positioned between the vertical guide rails 34, 36 for connection via a suitable valve coupling to a flexible air supply hose 52. A first end 42 of the control arm 25 is secured to air distribution conduit 29 and at an oppositely disposed second end 44 of the control arm 25 is attached proximate an end of the central air distribution conduit 27 in the mounting frame 12.

A hold-down bracket or rod 37 is provided between the vertical guide rails 34, 36, and is coupled to the air distribution line 22 and operates to prevent the diffusor rack from rising up by its own system buoyancy during standard operation. Guide brackets 90, which are fixed to hold-down rod 37, slidingly engage around guide rails 34, 36, respectively, to facilitate movement of the hold-down rod 37. A pneumatic or hydraulic source or jack system positioned on the walkway 20, when actuated, causes the hold-down rod 37 and air distribution conduit 29 to be pushed vertically downward between and along the vertical guide rails 34, 36 via the guide brackets 90, thereby lowering the mounting frame 12 and aeration elements 15 into the tank and water for placement on floor of the tank 14, as shown in FIG. 2A. The vertical guide rails 34, 36, being both secured to the floor of the tank 14 and the bridge 2 or walkway 20, therefore provide a stabilizing support for the hold-down bracket or rod 37 and air distribution conduit 29, without the necessity of securing the guide rails or other support structure to the walls of the tank.

It is also contemplated, however, that the vertical guide rail system 19 could be mounted and secured to the walls of a water treatment tank for use with the mounting frame assembly 6, without requiring the bridge assembly 2 and walkway 20 when the tank design renders the use of the bridge assembly 2 and walkway impractical, as discussed in detail below.

As shown in FIGS. 5A-5D, the mounting frame 12 includes at least two mounting rails 24, 26 arranged parallel and spaced from one another. A plurality of aeration elements 15 are positioned on the mounting frame 12, such that each of the two mounting rails 24, 26 is positioned proximate to opposite ends of the aeration elements 15. FIGS. 5C and 5D show elongated aeration elements having an oval cross section. As shown in FIGS. 5E and 5F, it is also contemplated that tubular aeration elements or disc aeration elements, respectively, or could be used with the frame assembly 6 and water treatment system 10 according to the present invention with the same effect.

At least two further mounting rails 28 are positioned perpendicular to mounting rails 24, 26 to form the substantially rectangular mounting frame 12. A central air distribution conduit 27 is positioned centrally in the mounting frame 12 to supply the aeration elements 15 with an airflow, in the manner to be described below. The aeration elements 15 are each coupled to the central air distribution conduit 27 via a suitable coupling to enable air flow into the aeration elements 15 and secured to the mounting rails 24, 26 with brackets 17. As shown in FIG. 5B, mounting brackets 17 are secured, for example screwed, onto mounting rails 24, 26. When the aeration elements are position onto the mounting frame, as shown in FIG. 5C, brackets 17 engage around the aeration elements 15 proximate to opposite ends of the aeration elements 15, so that the aeration elements 15 are thereby secured to the mounting rails 24, 26 and a length of each aeration element 15 extends beyond the respective mounting rail 24, 26. By way of example, the bracket device of U.S. Pat. No. 9,81,480 to the same inventor as the present application is referenced, the subject matter of which is incorporated herein by reference. The central air distribution conduit 27 in turn is connected to a further air distribution conduit 29 arranged perpendicular to the central air distribution conduit 27 and extending vertically upward to the bridge assembly 2, in particular, the walkway 20, for connection to an air supply provided via a flexible air hose 52 provided on the walkway 20. The air distribution conduit 29 extends upwardly from the mounting frame 12 and between vertical guide rails 34, 36 of the vertical guide rail system 19 described in greater detail below.

By way of example, the aeration elements 15 are shown as elongated aeration strip elements having a substantially oval cross-section, with an elastomeric and flexible tubular membrane having air slits provided only on a top surface of the aeration element when the membrane is placed around the aeration element, and an air inlet with a threaded connection to connection the aeration element to a distribution conduit that serves for the supply of gas or air. In this type of aeration element, the support member of the aeration element is made up of a rigid, hard plastic material having a corrugated, hollow profiled and with corrugated outer surfaces, such that a plurality of grooves is formed between the ridges of the corrugated surfaces, both on the inner and outer surfaces of the support member. However, as noted above, the mounting frame assembly can be used with tubular or disc-shaped diffusors/aeration elements, which are known in the relevant art, with the same effect as strip diffusors with an oval cross section (see, for example, FIGS. 5E and 5F).

As noted above, the mounting frame assembly is designed to provide buoyancy when the aeration elements are in place on the mounting frame 12. The frame components themselves are preferably made of a lightweight metal, such as stainless steel, although other suitable lightweight materials could be used to the same effect. The construction of the aeration elements 15, in particular, by their elongated design, whether tubular or flattened with an oval cross section, also provide buoyancy to the mounting frame assembly. (Reference is made to U.S. Pat. No. 9,70,752 by the same inventor as the present invention, the subject matter of which is incorporated by reference, with regard to an example of the elongated, oval-cross sectional aeration elements that could be utilized with the mounting frame assembly). While the hold-down bracket or rod 37 assists in lowering the mounting frame 12 with the aeration elements 15 in place into the tank, positioning the mounting frame 12 onto the floor of the tank, and maintaining the mounting frame 12 and aeration elements 15 in that position on the floor of the tank, the buoyancy of the mounting frame 12 with the aeration elements 15 may require adjustment of the air flow being fed into the aeration elements to facilitate in lowering the mounting frame 12 into the water. Airflow preferably is shut off for this particular aeration element and diffusor frame element, so that the aeration elements deflate to minimize buoyancy. For example, the air supply can be stopped via a shut off valve and air is then bled out of the air supply system via the aeration elements, allowing the mounting frame 12 to be more easily lowered into the water.

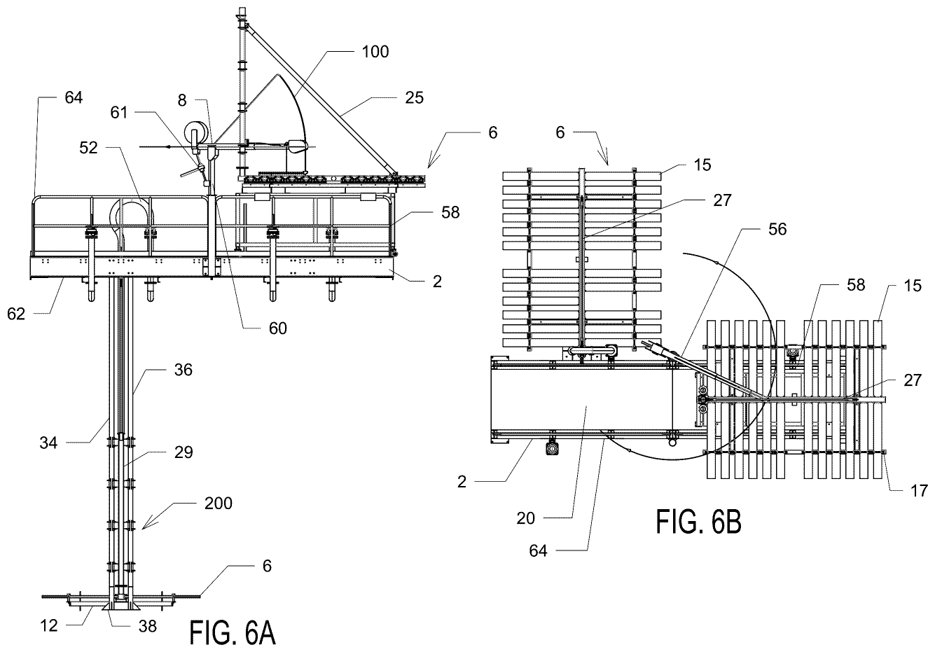

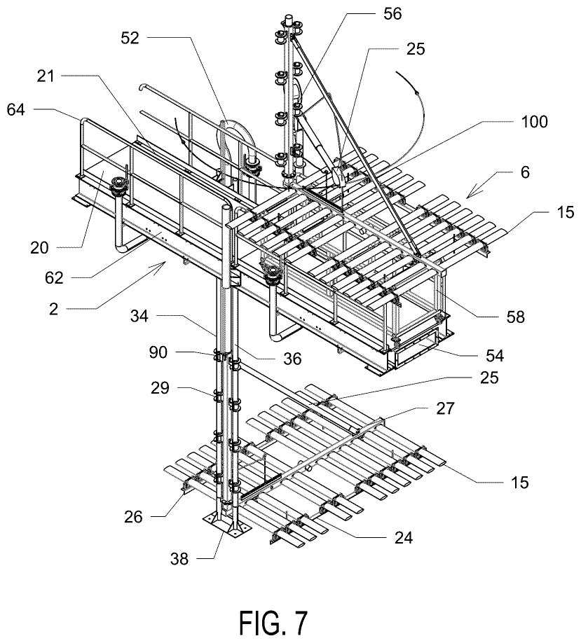

Referring to FIGS. 6A-6B and 7, the mounting frame 12 with the aeration elements 15 in place can be removed manually out of the tank by securing a lift cable 100 to mounting frame 12, via a connection flange, for example. The mounting frame 12 and aeration elements 15, therefore, can be pulled manually out of the water tank 14, for example with the crane 8 and lift cable 100, for maintenance or replacement of components.

The vertical guide rail system 19 is secured at an upper end via one or more upper end fixing brackets 40 to the bridge 2 that extends from a wall or walls 82 of the tank over the surface of the tank, extending either completely or partially between the walls of the tank. While the figures show a circular tank, the water treatment system 10 also can be used for any other tank geometry, such as square or rectangular tanks. The air distribution line 22 is secured to a flexible hose 52, which in turn connects to one or more air supply conduits 54 running on the outside of a bridge railing or is mounted beneath the walkway 20 of the bridge 2, for supplying air to the aeration elements 15 in the mounting frame 12.

As noted above, the water treatment system 10 includes the bridge 2, the mounting frame assembly 6, the vertical guide rail assembly 19, a lifting crane 8, and a transport device 58. The transport device, or cart, 58 can be a wheeled cart, shown by way of example as cart 58, for moving the mounting frame 12 and aeration elements 15 along the bridge 2 and walkway 20, into position for deployment into the water tank or moving the mounting frame 12 and aeration elements 15 off the bridge 2 for repair or maintenance.

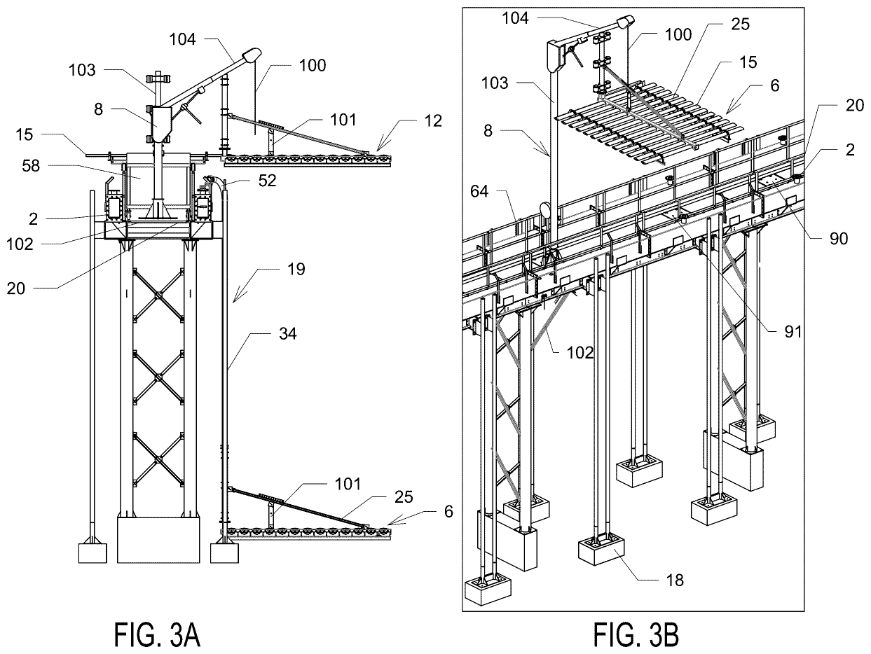

As best shown in FIGS. 3A-3B, the lifting and pivoting crane 8 includes a mounting base 102, a post 103, and a lifting and pivoting arm 104. The mounting base 102 is secured to the walkway 20 of the bridge 2. In this connection, the walkway 2 is provided with a plurality of mounting plates 90 that are secured to the surface of the walkway 2, each mounting plate 90 having a plurality of through-holes 91 for securing the mounting plate 102. The crane 8 preferably is positioned between two vertical guide rail assemblies 19, so that one crane 8 can service both assemblies 19 by pivoting the crane's lifting and pivoting arm 104. The pivoting and lifting arm 104 extend beyond an upper rail 64 of the bridge 2 at a height sufficient to allow the crane 8 to engage, lift, and pivot the mounting frame 12 onto the bridge, specifically, onto the transport device 58, shown here as moveable cart or frame, positioned on the walkway 20. The crane 8 includes a pulley line 100 for attachment to a flange or other element on the central air conduit 27 in the mounting frame 12.

After the mounting frame 12 has been removed from the water tank via the vertical guide system, 19, the crane 8, in a known manner, then is operated to manually move the mounting frame 12 from a position disposed above the water and perpendicular to the bridge 2 and walkway 20 into position onto the transfer cart 58, as shown in FIGS. 6A and 6B. The mounting frame 12 then can be released from the pulley line 100 of the crane 8 and transported via the moveable cart 58 off the bridge 2 and walkway 20 and onto the transfer station 22 to be removed from the bridge 2 (FIG. 15). Likewise, the mounting frame 12 and aeration elements 15 can be loaded onto the transfer cart 58 at the transfer station 22 and moved onto the bridge 2 and walkway 20 from the transfer station 22, so that the mounting frame 12 and aeration elements 15 can be deployed into the tank, either initially or after servicing.

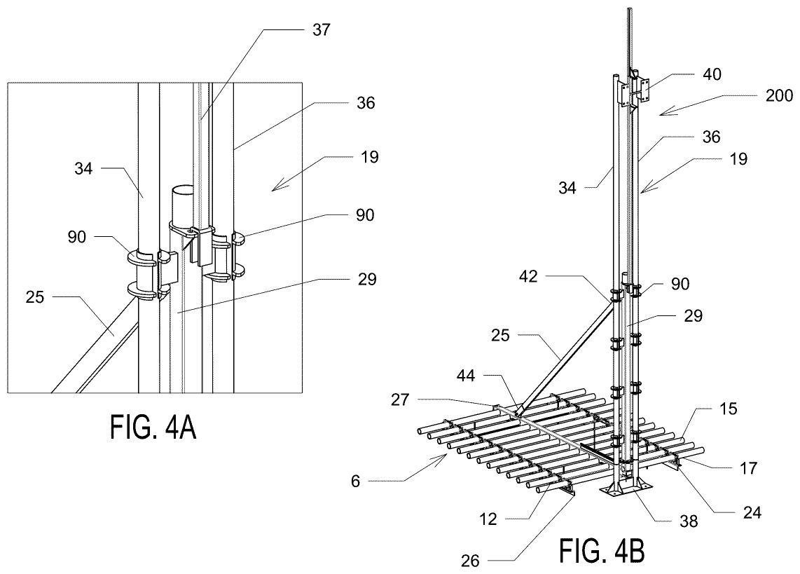

FIGS. 4A through 4B show further perspective and end views, respectively, of the water treatment system 10, including the bridge 2, the vertical guide rail system 19, the retrievable mounting frame assembly 6, and the cart 58. As shown in FIGS. 4A and 4B, the mounting frame assembly 6 may further include a stabilizing arm 101 secured at one end to the control arm 25 and at an opposite end to the frame 12 to facilitate in raising and lowering the frame 12 and aeration elements 15 into and out of the water in a level manner.

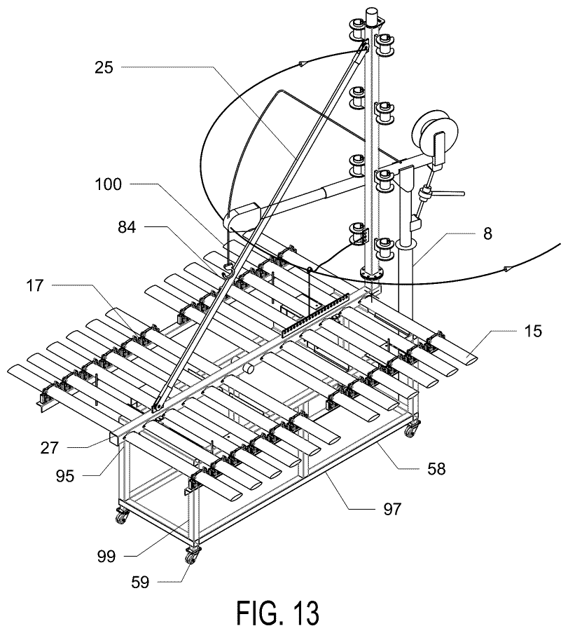

FIG. 7 shows a view of the mounting frame 12 and crane 8, with the mounting frame 12 in place on a moveable transport device 58, such as a wheeled cart or frame. As can be seen also from FIG. 13, the transfer cart 58 is generally formed as a lightweight but sturdy rectangular steel or metal frame with upper rails 95, lower rails 97, and vertical rails 99 extending between and connecting the upper rails 95 and lower rails 97. The transfer cart 58 includes wheels or castors 59 positioned on the lower rails 97 to facilitate movement of the cart 58 in guide tracks 21 formed in the walkway 20 of the bridge 2. The cart 58 is dimensioned to conform to the width of the bridge 2 and walkway 20 and has a height that enables the mounting frame 12 to be positioned on the cart 58 such that the mounting frame 12 with the aeration elements 15 have adequate clearance over the upper rail 64 of the bridge 2 and walkway 20 during transport of the transfer cart 58 along the walkway 20.

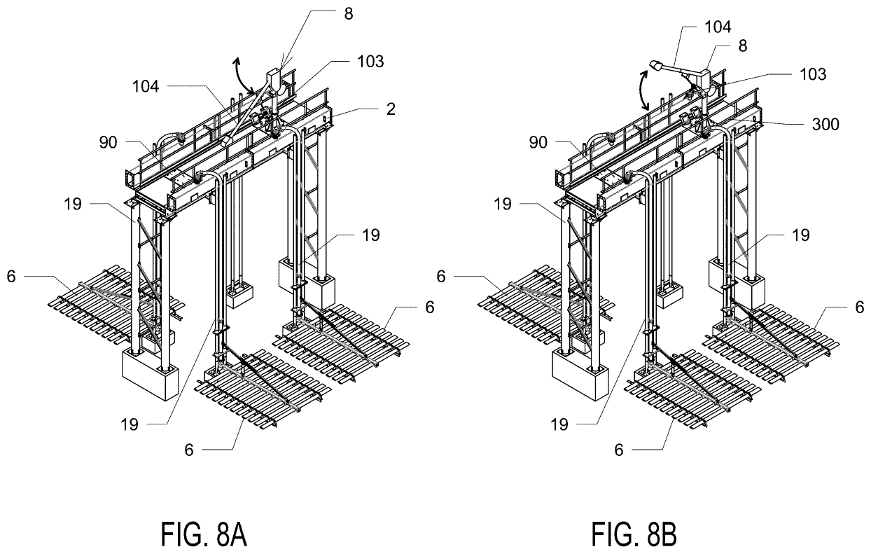

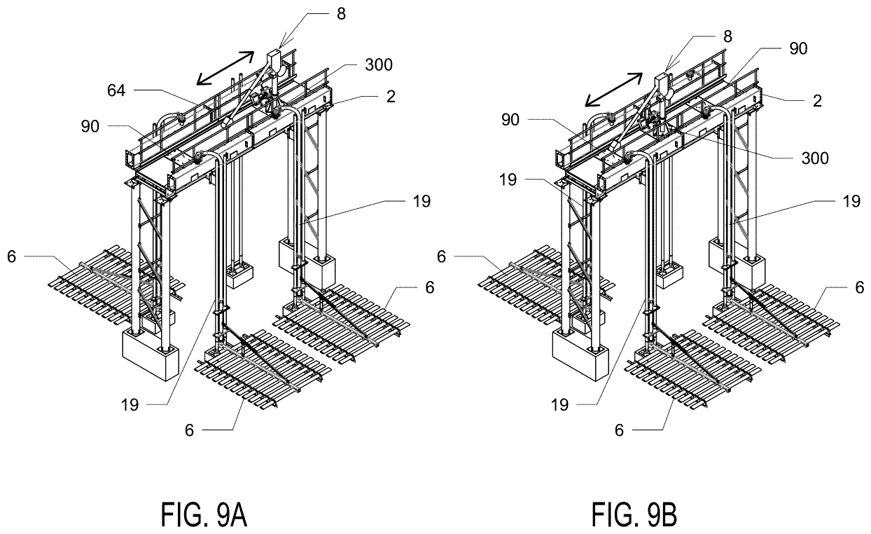

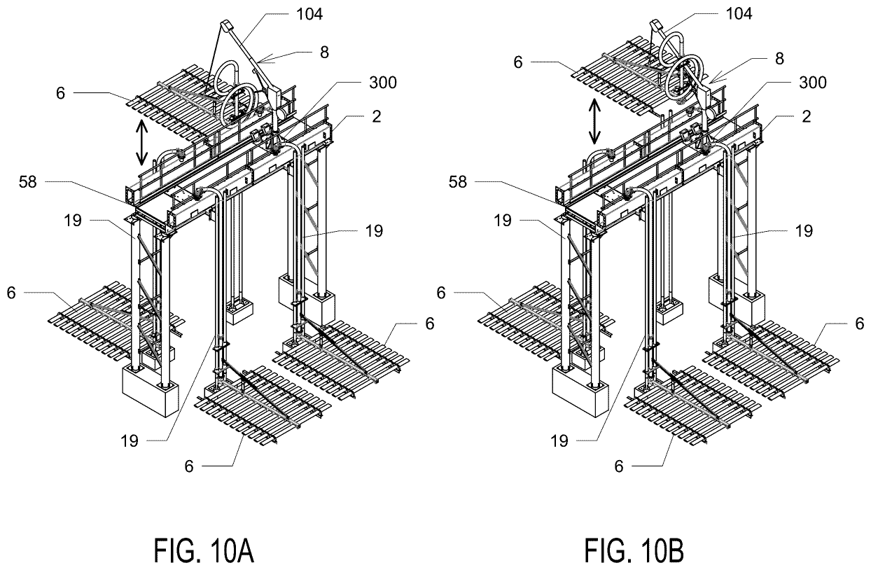

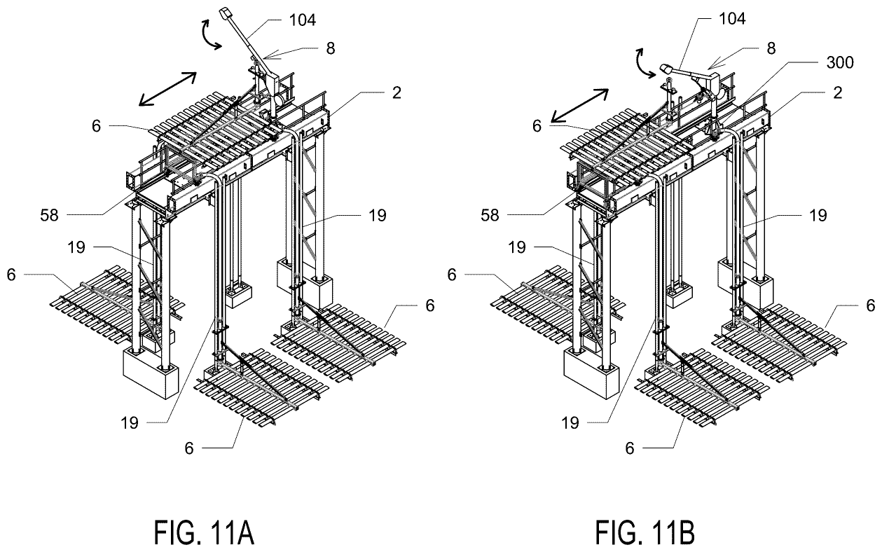

While the crane 8 was described above as mounted and fixed to the bridge 2, as shown in FIGS. 9A through 13D, a further embodiment of the crane 8 contemplates that the crane 8 is more readily transferable between mounting plates 90 fixed to the walkway 20. The crane 8 is similar in features to the crane 8 described above, except in this embodiment, the mounting base 102 can be fixed instead to a transfer trolley 300. The transfer trolley 300 has a substantially rectangular base plate 302 and wheels and/or castors 304 positioned on and mounted via mounting brackets 310 to opposite sides of the base plate 302. The mounting base 102 is secured to the base plate 302 of the transfer trolley 300 via a plurality of bolts, for example. Further bolts 308 secure the base plate 302 of the transfer trolley 300 to the walkway 20 by engaging through the through-holes 91 provided in the mounting plates 90. In operation, and as illustrated in FIGS. 8A and 8B, the crane 8 is secured to the transfer trolley 300, and the transfer trolley 300 secured to a mounting plate 90 on the walkway 20 proximate to at least one vertical guide rail assembly 19. FIGS. 9A and 9B illustrate transfer of the crane 8 via the transfer trolley 300 between mounting plates 90 on the walkway 2. Once the transfer trolley 300 and therefore the crane 8 are secured to the mounting plates 90 on the walkway 2, the crane 8 is then ready to be operated to live and or lower the frame 12 and aeration elements 14 for deployment on the vertical guide rail system (FIGS. 10A and 10B) or for transfer of the frame 12 and aeration elements 15 onto and off the transfer cart 58 (FIGS. 11A-11B). As shown in FIGS. 12D and 12E, for example, the wheels engage and move in the guide tracks 21 on the walkway 20 which are also used by the transfer cart 58. When it is necessary to transfer the crane 8 to a different location on the bridge 2, the bolts 306 can be loosened/removed and the transfer trolley 300 manually relocated along the guide tracks 21 for securing to a further mounting plate 90 on the walkway 20.

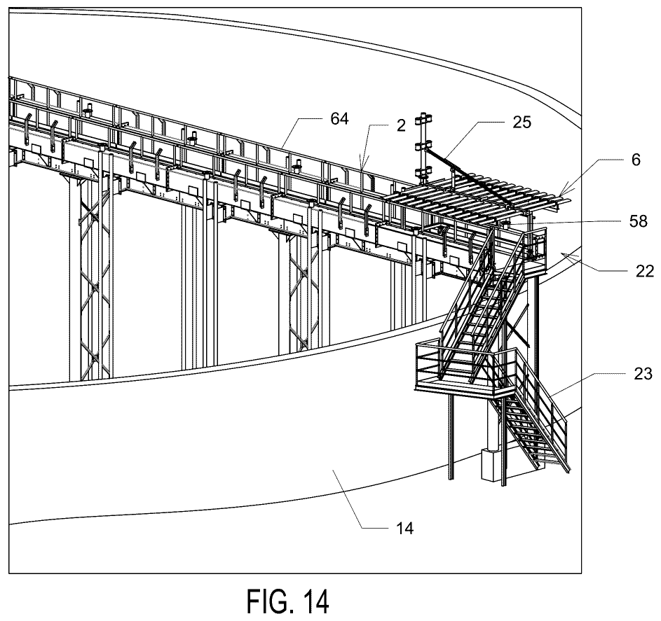

As noted above, the water treatment system 10 includes at least one transfer station 22, as shown in FIG. 14. The transfer station 22 is positioned at one or both ends of the bridge 2 and walkway 20 and includes a platform 400 for receiving the transfer cart 58 with the frame assembly positioned thereon. The transfer station 22 is positioned to extend above and over the wall of the tank 14 so that the platform 400 is disposed outside of the tank 14. When a frame 12 with aeration elements is to be deployed in the tank 14, the transfer cart 58 is moved to the transfer station by an operator and the frame 12 with aeration elements 15 can be loaded onto the cart 58 via a mobile crane or forklift at the transfer station 22 and then transported from the transfer station 22 along the walkway 20 of the bridge 2 into position for deployment. Likewise, when a frame 12 with aeration elements 15 must be removed from the tank 14, the transfer cart 58 with the frame 12 with aeration elements 15 is moved along the length of the bridge 2 to the transfer station 22 where it can be picked up with the forklift or mobile crane and be serviced on the grounds outside the tank, or brought to a maintenance area or workshop of the waste water treatment plant.

In a further aspect of the present invention, a wall-mounted system is provided when the tank size and configuration is not suitable for using the bridge and walkway assembly. The wall-mounted system may be used, for example, when the tank width is less or equal to 10 m [34 ft.]; when a circular tank has a diameter of less or equal to 15 m [15 ft.]; when enough diffusor capacity, effective membrane area—Nm3/h per m2 [SCFM per ft2] of SOR [standard oxygen required] kg O2/h [lbs. of O2/h] for the aerobic digestion and/or nitrification process can be installed on the accessible tank wall, without the need of an additional bridge to install additional retrievable diffusor elements/racks; or when additional mixer/separate mechanical mixing is present to prevent the sludge from settling in case the tank bottom/floor is not covered sufficiently with diffusor elements

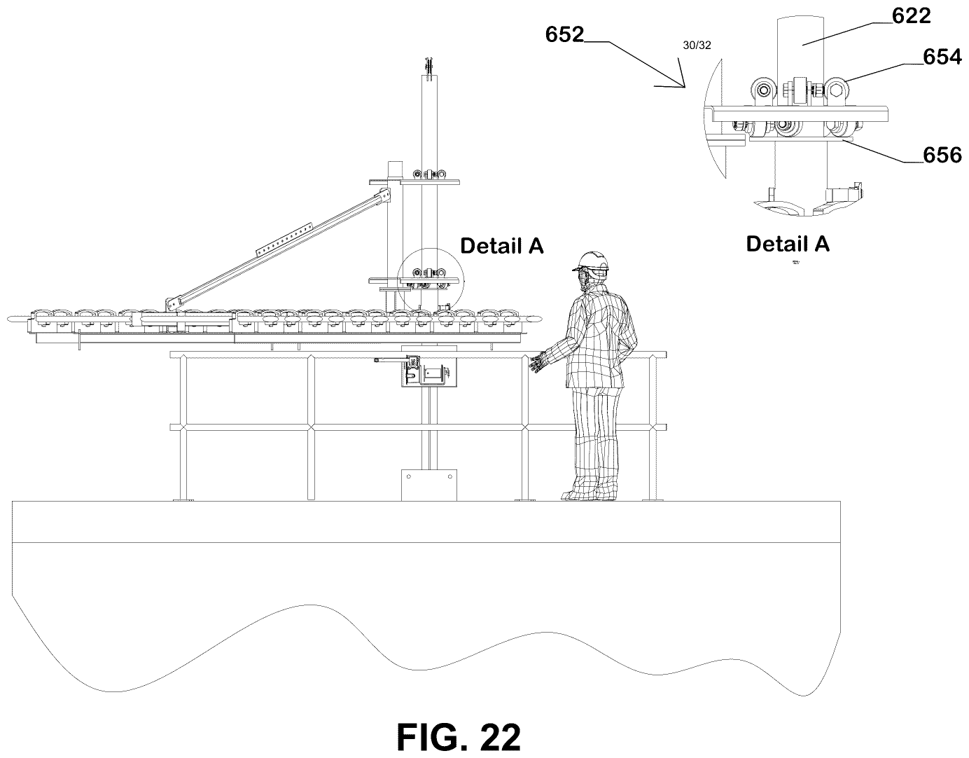

FIGS. 15-24 illustrate wall-mounted a guide rail and retrievable diffusor frame assemblies configured to be mounted to a wall of a treatment tank.

In one aspect, FIGS. 15 and 16 show a wall-mounted, guide rail system 519, the components of which are essentially the same as those shown in FIGS. 4A and 4B. As described above, the vertical guide rail assembly 519 serves for transferring the frame assembly 506 between a position above the water's surface (FIG. 16) and to a position on the floor 503 of a tank 514 (FIG. 16). The vertical guide rail assembly 519 includes preferably two vertical guide rails 534, 536 positioned parallel to one another and extending from an upper edge of a tank wall 500 to the floor 503 of the tank 514, lower fixing brackets 538 for securing the vertical guide rail assembly 519 to the floor 503 of the tank 514, and an upper fixing bracket 540 for securing the vertical guide rail assembly 519 to the tank wall 500. As described above with reference to FIGS. 4A and 4B, a flexible hose provides a supply of air to an air distribution conduit 529 and is positioned between the vertical guide rails 534, 536 for connection via a suitable valve coupling to a flexible air supply hose (not shown). A first end 542 of the control arm 525 is secured to air distribution conduit 529 and at an oppositely disposed second end 544 of the control arm 525 is attached proximate an end of the central air distribution conduit 527 in the diffusor rack, or mounting frame 512.

To avoid repetition, reference is made to the above description of FIG. 4A regarding the hold-down bracket or rod, guide brackets and the operation for moving the diffusor rack/mounting frame 512 between its upper position shown in FIG. 16 and the lower position on the floor 503 of the tank 514, as shown in FIG. 15. The vertical guide rails 534, 536, both secured to the floor of the tank 514 and the tank wall 500 therefore provide a stabilizing support for the hold-down bracket or rod 537 and air distribution conduit 529.

With regard to the diffusor rack or mounting frame shown in FIGS. 15-24, to avoid repetition, reference is made to the description of the diffusor mounting rack or frame described above with reference to FIGS. 5A-5D

When the diffusor frame assembly 506 is raised to the position shown in FIG. 16, the frame assembly 506 may be disengaged from the guide rail assembly 519 and removed to the platform 502 of the tank, where it can be serviced or replaced.

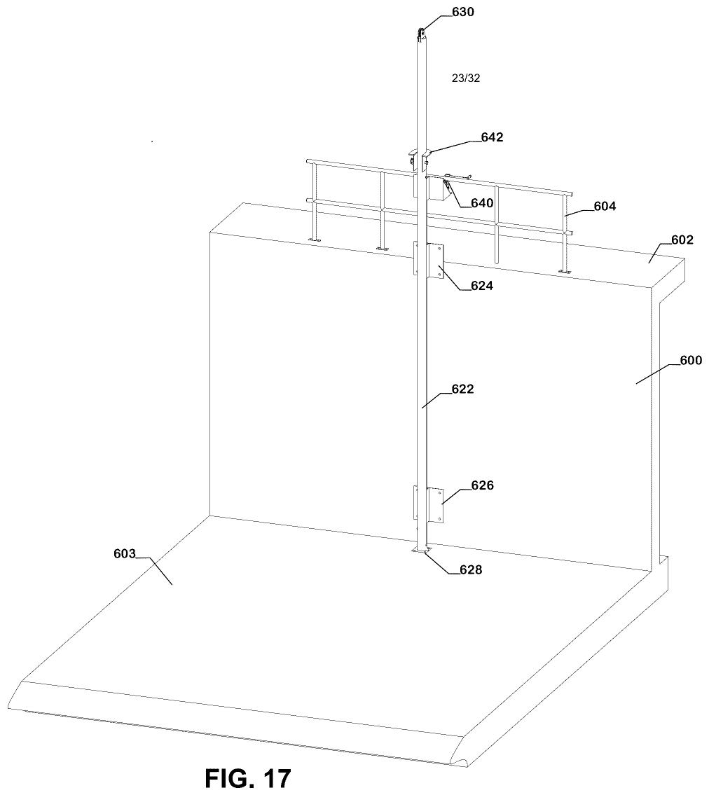

FIGS. 17-24 show a further aspect of a wall-mounted guide rail and retrievable diffusor rack assembly.

As can be seen in FIGS. 17-20, the wall-mounted system 620 includes a vertical post or guide rail 622 for guiding the diffusor rack or frame assembly 606. (To avoid repetition, it is noted that the elements of the diffusor rack or frame assembly 606, as well as the aeration elements mounted to the diffusor frame assembly are the same as those described with reference to FIG. 4A and FIGS. 15 and 16 above.) The guide rail 622 is secured to the tank wall 600 with an upper wall mount 624, a lower wall mount 626, and a foot mount 628. The guide rail 622 extend from the floor 603 of the tank to a position above the tank wall 600 or wall platform 602.

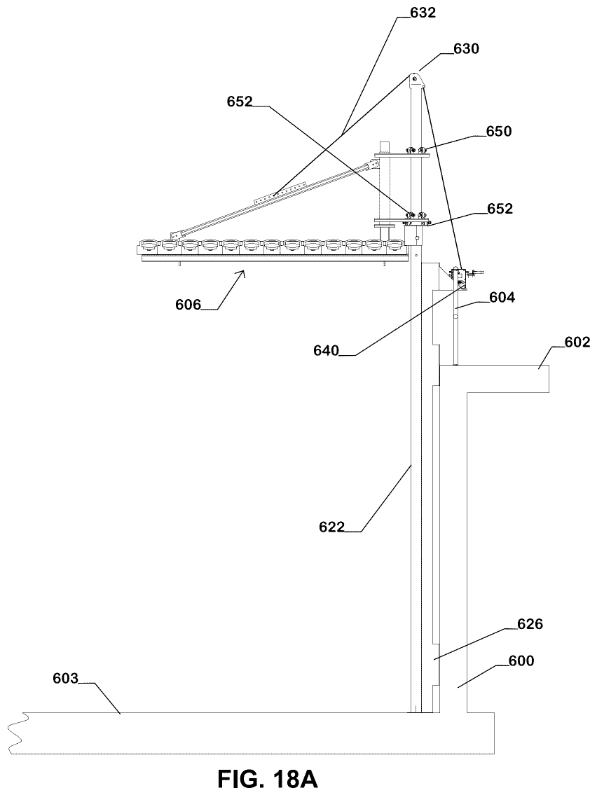

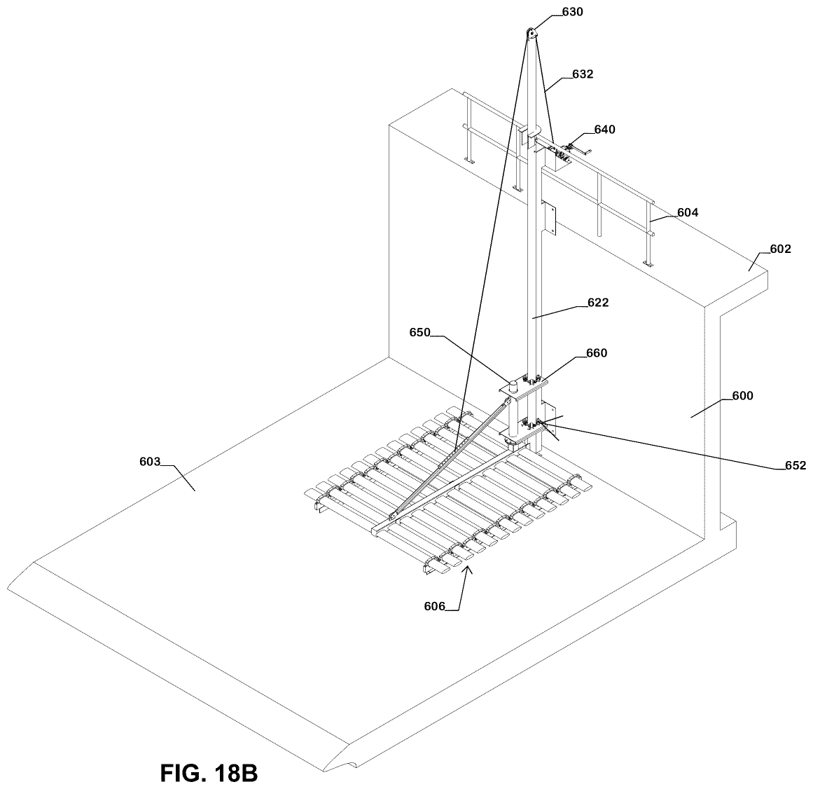

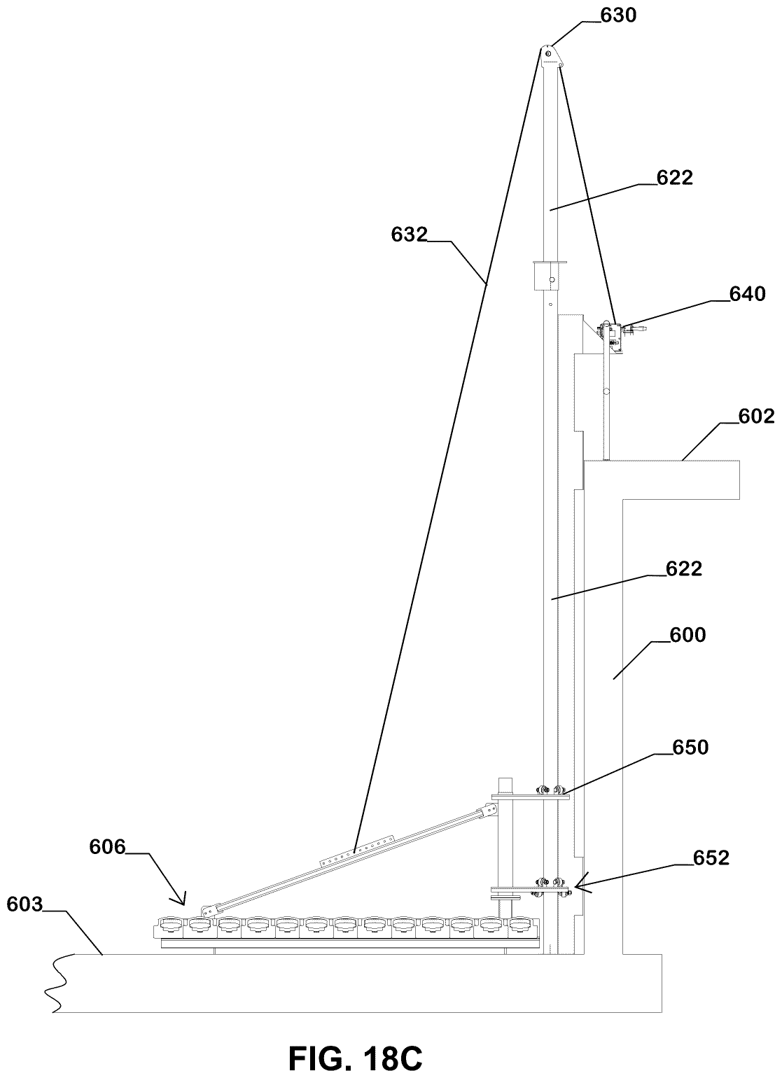

As shown in FIGS. 18A-18C, a pulley 630 is provided at the upper end of the guide rail 622. The pulley 630, includes a wheel with a grooved rim around which a cable 632 passes. The pulley 630 operates to change the direction of a force applied to the cable 632 for lifting the diffusor rack 606.

As shown in FIG. 18B, for example, an air supply connection to a camlock removable coupling 650 is provided to connect a flexible hot air rubber hose connection to a butterfly shut off valve to an air supply yard piping (not shown).

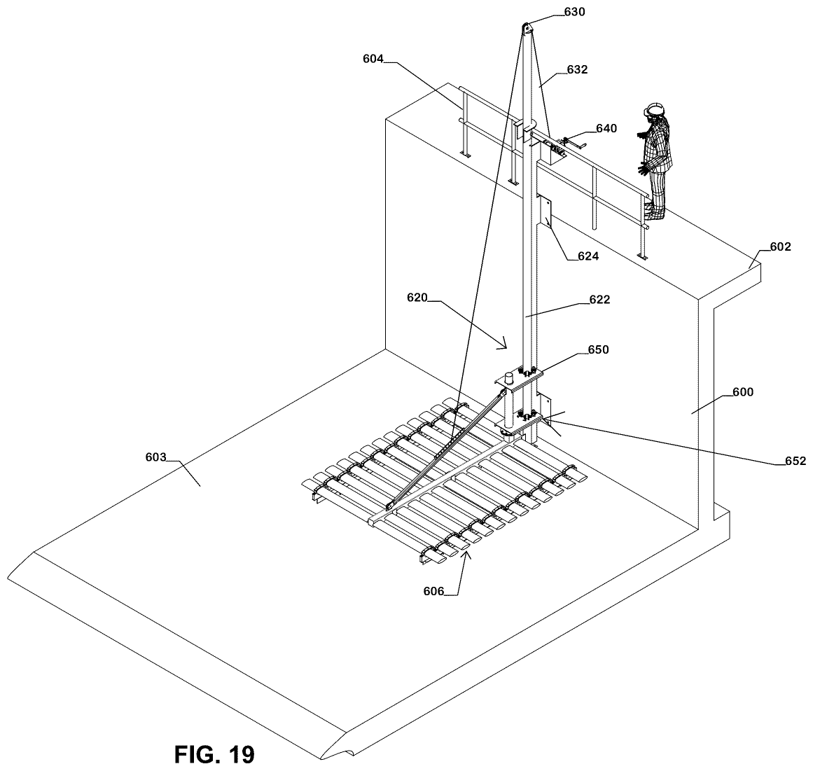

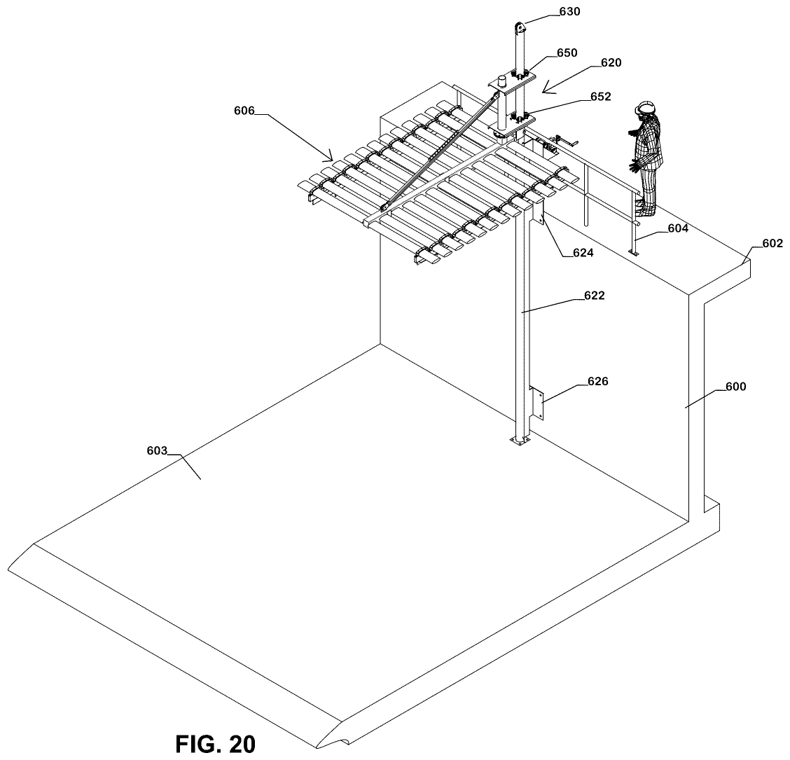

FIGS. 19-20 provide further view of the wall-mounted system. FIG. 19 again shows the diffusor frame or rack 606 in a submerged position on the floor of the tank, while FIG. 20 shows the diffusor frame or rack 606 after being raised from the submerged position to an elevation about the tank wall 600. In the example shown in the accompanying figures, the tank platform 602 has a railing 604, typically around the perimeter of the platform 602, although here only a section of the railing 604 is shown. A portable, removable hand-operated or motorized winch 640 is mounted to the guide rail 622, and the pulley 630 and cable 632 cooperate with the portable winch 640 for raising and lowering the diffusor rack 606.

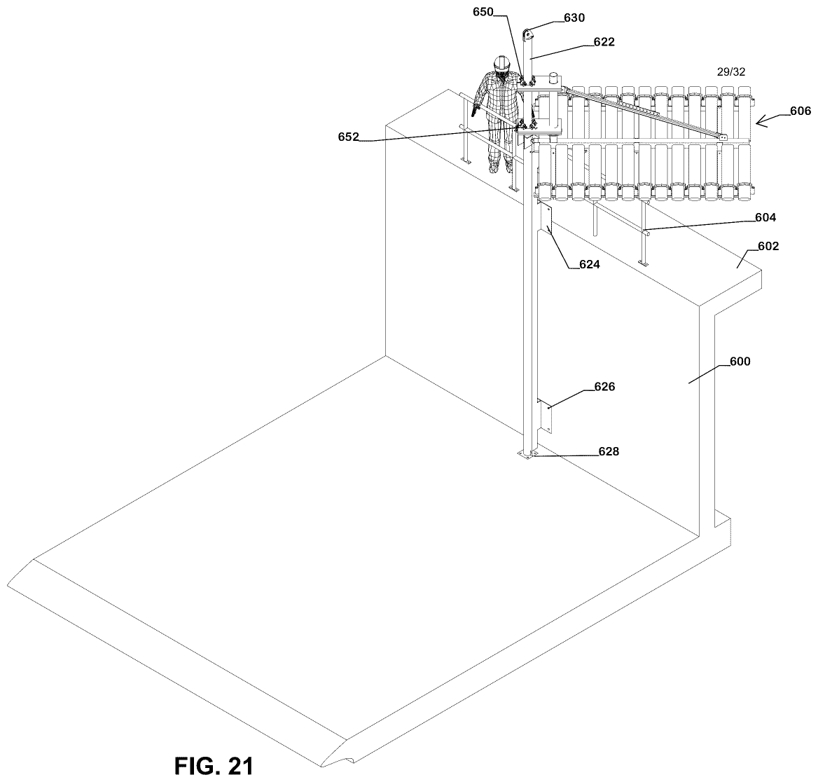

As shown in FIG. 21, for example, an advantage of the wall-mounted system according to this aspect of the invention is the ability of the diffusor rack 606 to be swiveled out of a position perpendicular to the tank wall 600 once the diffusor rack 606 is raised out of the tank and is positioned proximate to the platform 602. The swiveling capability is made possible by the configuration of components to be described next.

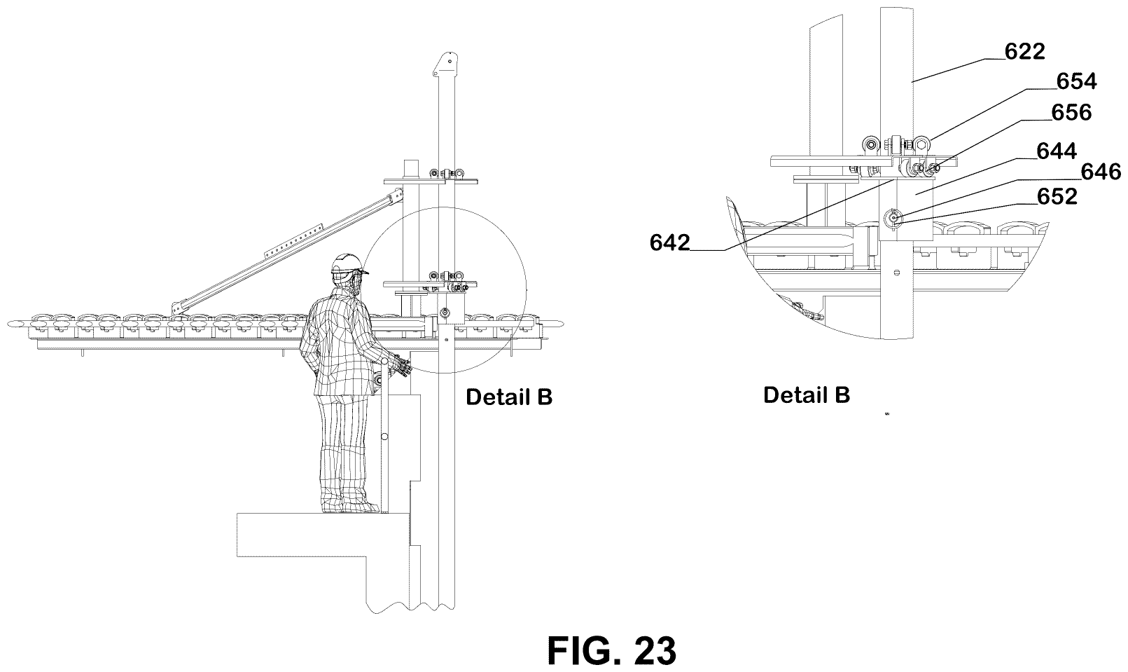

A moveable swivel plate 642 includes a mounting yoke 644 and locking pin 646, as shown in the detail view in FIG. 23. The moveable swivel plate 642 is installed to the guide rail 622 when diffuser rack assembly 606 is raised above or clears the top of the railing 604 elevation. A removeable swivel plate 642 includes a mounting yoke 644 that is secured by a locking pin 646. The lifting cable 632 is relaxed. A diffuser rack assembly 606 rests by the rollers 654 and 656 on the swivel plate 642. A diffuser rack assembly 606 can be freely swiveled around the guide rail 622 towards the platform 602 for access of the diffusers for maintenance or replacement, as shown in FIG. 21.

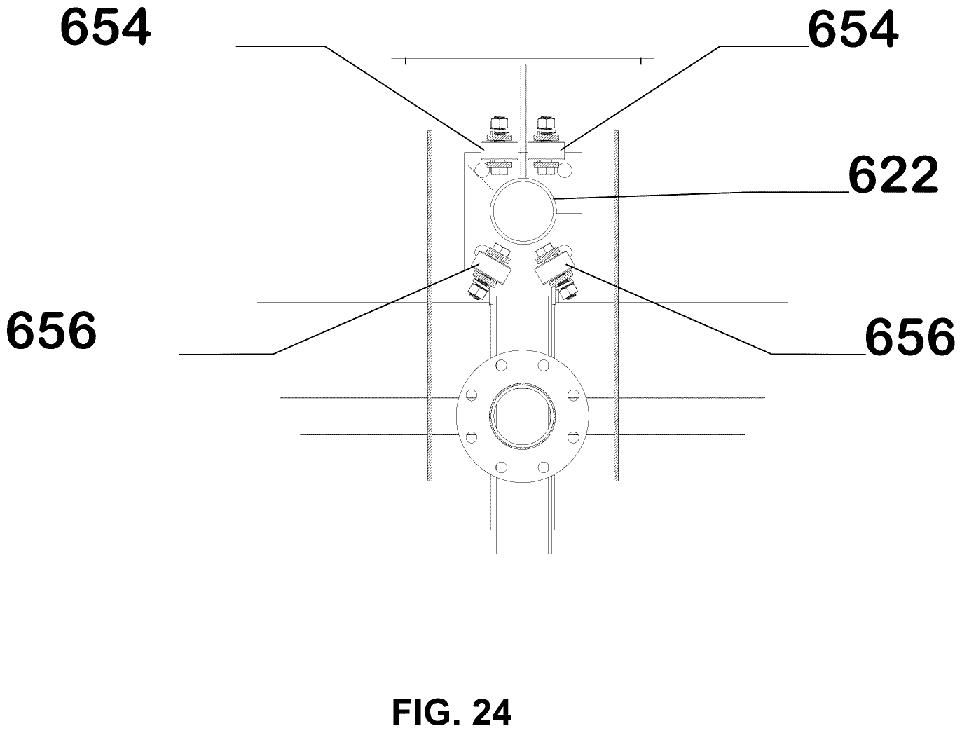

Four upper guide rollers 650 are offset at 90° to embrace the guide rail 622 and facilitate is movement from the raised position (for example, as shown in FIG. 18A) to the lowered position (for example, as shown in FIG. 18B). Lower guide roller assembly 652 includes guide rollers 654 and swivel rollers 656 (see detail view of lower guide roller assembly with guider rollers and swivel rollers in FIG. 24). The lower guide and swivel rollers 654, 656 are configured to keep the diffuser rack 606 perpendicular to the tank wall 600 when in the submerged cv state in the tank and to swivel the diffuser rack 606 above the railing 604 elevation. In particular, the swivel rollers 656 serve to maintain the diffuser rack 606 in perpendicular to the tank wall 600 in the submerged state and to swivel the rack when the diffuser rack 606 is retrieved above the railing 604. The guide rollers 654, preferably provided as a set of four guide rollers although more or fewer rollers could be utilized to the same effect, are offset at 90° to embrace the guide rail 622 as described above. The guide rail 622 operates to guide the guide rollers 650, 652 and to maintain the diffuser rack 606 in a position perpendicular to the tank wall 600 in the submerged state.

When the diffusor rack 606 must be retrieved from the tank floor 603 from a submerged state to a position above the railing 604 (see FIG. 18A), the winch 640, pulley 630, and cable 632 are operated cooperatively to raise the diffusor rack 606, either manually or with an electric winch. Once the diffusor rack or frame 606 is positioned above the elevation of the railing 604, the diffusor rack 606 is swiveled or pivoted around the guide rail 622 via the guide rollers 650, 652, 654, 656 to enable access by an operator to either repair, maintain, or replace the diffusors or mounting rack. Although in the examples shown, elongated strip diffusors are used, as described above with reference to the general description of the diffusor frame and rack in FIGS. 5E and 5F, tube or disc type diffusors may also be used with the wall-mounted assembly.

The present invention is, of course, in no way restricted to the specific disclosure of the specification and drawings, but also encompasses any modifications within the scope of the appended claims.

I claim:

1. A wall-mounted retrievable diffusor system for a water treatment tank, comprising:
at least one guide rail assembly mounted to a wall of the tank and extending from a floor of the tank to an upper edge of the wall;
at least one retrievable mounting frame assembly releasably mounted on the guide rail assembly; and
a plurality of aeration elements secured to the at least one retrievable mounting frame assembly.

2. The diffusor system of claim 1, wherein the at least one retrievable diffusor assembly comprises:
at least one retrievable mounting frame assembly, comprising:
a frame;
a plurality of mounting brackets to secure the aeration elements to the frame; and
a first air distribution conduit coupled to the aeration elements for supplying an air flow to the aeration elements.

3. The diffusor system of claim 1, wherein the at least one guide rail assembly is configured to move the at least one retrievable mounting frame assembly between a first position above the upper surface of the water to a second position below the surface of the water.

4. The diffusor system of claim 1, wherein the at least one guide rail assembly comprises:
at least one guide rail;
a second air distribution conduit coupled to the first air distribution conduit; and
a hold-down rod positioned between the guide rails and connected to the at least one retrievable mounting frame assembly, wherein the hold-down rod is configured to facilitate movement of the at least one retrievable mounting frame assembly along the guide rails between the first position and the second position.

5. The diffusor system of claim 2, wherein the at least one retrievable mounting frame assembly further comprises a control arm having first and second opposite ends and being secured to the frame at the first end.

6. The diffusor system of claim 4, wherein the hold-down rod is connected to the second end of the control arm.

7. The diffusor system of claim 1, wherein the at least one guide rail assembly comprises at central guide rail and at least one guide roller that engages around a central guide rail to guide the at least one mounting frame when moving along the central guide rail.

8. The diffusor system of claim 7, wherein the at least one guide roller is configured to maintain the at least one mounting frame in a position perpendicular to the tank wall when the at least one mounting frame is moved along the central guide rail.

9. The diffusor system of claim 7, wherein the at least one guide rail assembly further comprises at least one swivel roller configured to engage around the central guide rail and pivot the at least one mounting frame out of a position that is perpendicular to the tank wall when the at least one mounting frame is positioned above a top elevation of the tank wall.
